(19) United States
(12) Patent Application Publication
(10) Pub. No.: US 2024/0376297 A1
(43) Pub. Date: Nov. 14, 2024

(54) POLYMER BLENDS COMPRISING POST-CONSUMER RECYCLED RESIN

(71) Applicant: Dow Global Technologies LLC, Midland, MI (US)

(72) Inventors: Akanksha Garg, Pearland, TX (US); Yongchao Zeng, Houston, TX (US); Andrew T. Heitsch, Lake Jackson, TX (US); Christopher M. Thurber, Midland, MI (US); Carmelo Declet Perez, Pearland, TX (US); Jacquelyn A. DeGroot, Sugarland, TX (US); Jin Wang, Lake Jackson, TX (US); Mridula Kapur, Midland, MI (US); Amit K. Chaudhary, Lake Jackson, TX (US)

(73) Assignee: Dow Global Technologies LLC, Midland, MI (US)

(21) Appl. No.: 18/691,681

(22) PCT Filed: Oct. 11, 2022
(86) PCT No.: PCT/US2022/077896

§ 371 Date: Mar. 13, 2024

Related U.S. Application Data
(60) Provisional application No. 63/256,252, filed on Oct. 15, 2021.

(51) Int. Cl. C08L 23/06; C08J 5/18; C08L 23/08

(52) U.S. Cl. CPC C08L 23/06; C08J 5/18; C08L 23/0815; C08J 2323/06; C08J 2323/08; C08J 2423/06; C08J 2423/08; C08L 2203/16; C08L 2205/025; C08L 2207/062; C08L 2207/066; C08L 2207/20

(57) ABSTRACT

Embodiments of the present disclosure are directed to post-consumer recycled (PCR) resin formulations comprising: PCR resin comprising a blend of polyethylene recovered from post-consumer material, pre-consumer material, or combinations thereof; and virgin polyethylene resin formulation, wherein the virgin polyethylene resin formulation comprises: a density from 0.910 to 0.950 g/cc, an improved comonomer content distribution (iCCD) wt. fraction greater than 30 wt. % at a temperature range of 35 to 90° C., and an iCCD wt. fraction greater than 8 wt. % at a temperature range of 99 to 115° C. The PCR resin formulation comprises an overall density of from 0.910 to 0.930 g/cc; an iCCD second elution peak occurring at a temperature greater than 99° C.; an iCCD wt. fraction greater than 6 wt. % at a temperature range of 99 to 115° C.; and an iCCD wt. fraction greater than 60 wt. % at a temperature range of 35 to 90° C.

### CROSS-REFERENCE TO RELATED APPLICATIONS

This application claims the benefit of U.S. Provisional Application Ser. No. 63/256,252 filed Oct. 15, 2021, the entire disclosure of which is hereby incorporated herein by reference.

### TECHNICAL FIELD

Embodiments of the present disclosure generally relate to polymer blends comprising a post-consumer resin (PCR), and products produced therefrom.

### INTRODUCTION

Post-consumer resin (PCR) plays an increasingly larger role in environmental sustainability initiatives and efforts in today's world. PCR provides a way for industries to re-process and re-incorporate materials into consumer articles, which limits the consumption of new resources, permits the re-use of old materials, and sustainably creates the production of new articles. The novelty and inherent variability of PCR presents challenges to industries striving to use PCR in effective ways. PCR typically consists of a mélange of materials (e.g., polymer blends, organic, or inorganic material). As a result, PCR and its properties can have a high degree of variability in each lot, batch, or individual resin, and its precise constituents, composition, and corresponding characteristics and properties often fluctuate. It can therefore be difficult to diagnose or predict how polymer blends incorporating PCR will perform or react, and so it can be challenging to effectively incorporate PCR to produce consumer articles with uniform, validated, or desirable characteristics. For example, PCR rich in polymeric material is a prime candidate for film or sheet applications, but such films or sheets, when formed from a polymer blend including PCR, can be compromised on mechanical properties, such as toughness and stiffness.

Accordingly, there remains a need for sustainable and efficiently produced films that include PCR while maintaining or minimizing the reduction of other desirable mechanical properties, such as toughness and stiffness.

### SUMMARY

Embodiments of the present disclosure address this desire for sustainability while maintaining the desired mechanical properties, and in some instances, allowing for downgauging the film thickness of PCR-incorporated films.

In one embodiment, a post-consumer recycled (PCR) resin formulation is provided. The PCR resin formulation comprises: PCR resin comprising a blend of polyethylene recovered from post-consumer material, pre-consumer material, or combinations thereof; and a virgin polyethylene resin formulation, wherein: the virgin polyethylene resin formulation comprises: a density from 0.910 to 0.950 g/cc, an improved comonomer content distribution (iCCD) weight (wt.) fraction greater than 30 wt. % at a temperature range of 35 to 90° C., the iCCD wt. fraction being defined as a ratio of the mass eluted at temperatures from 35 to 90° C. for the virgin polyethylene resin to the total mass eluted for the virgin polyethylene resin when measured using an iCCD curve of mass eluted versus temperature, and an iCCD wt. fraction greater than 8 wt. % at a temperature range of 99 to 115° C. The PCR resin formulation comprises an overall density of from 0.910 to 0.930 g/cc, an iCCD second elution peak occurring at a temperature greater than 99° C., an iCCD wt. fraction greater than 6 wt. % at a temperature range of 99 to 115° C., the iCCD wt. fraction being defined as a ratio of the mass eluted at temperatures from 99 to 115° C. for the PCR resin formulation to the total mass eluted for the PCR resin formulation when measured using an iCCD curve of mass eluted versus temperature; and an iCCD wt. fraction greater than 60 wt. % at a temperature range of 35 to 90° C.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describes various embodiments and are intended to provide an overview or framework for understanding the nature and character of the claimed subject matter. The accompanying figures are included to provide a further understanding of the various embodiments, and are incorporated into and constitute a part of this specification.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a graphical illustration of the dart versus secant modulus for the experimental films having 21% PCR in Table 14 according to one or more embodiments of the present disclosure; and

FIG. 2 is a graphical illustration of the dart versus secant modulus for the experimental films having 50.4% PCR in Table 14 according to one or more embodiments of the present disclosure.

### DETAILED DESCRIPTION

### Definitions

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used herein, the term “polymer” refers to a polymeric compound prepared by polymerizing monomers, whether of the same or a different type. The term polymer thus embraces the term homopolymer (employed to refer to polymers prepared from only one type of monomer, with the understanding that trace amounts of impurities can be incorporated into the polymer structure), and the term copolymer or interpolymer. Trace amounts of impurities (for example, catalyst residues) may be incorporated into and/or within the polymer. A polymer may be a single polymer or a polymer blend.

“Polyethylene” or “ethylene-based polymer” means polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used herein, the term “LDPE” or “low density polyethylene” refers to an ethylene homopolymer prepared using a free radical, high-pressure (>100 MPa (for example, 100-400 MPa)) polymerization. LDPE resins typically have a density in the range of 0.916 to 0.935 g/cm³.

The term “LLDPE” or “linear low density polyethylene includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

The terms “pre-consumer recycled polymer” and “post-industrial recycled polymer” refer to polymers, including blends of polymers, recovered from pre-consumer material, as defined by ISO-14021. The generic term pre-consumer recycled polymer thus includes blends of polymers recovered from materials diverted from the waste stream during a manufacturing process. The generic term pre-consumer recycled polymer excludes the reutilization of materials, such as rework, regrind, or scrap, generated in a process and capable of being reclaimed within the same process that generated it.

The term “post consumer resin” (or “PCR”), as used herein, refers to a polymeric material that includes materials previously used in a consumer or industry application i.e., pre-consumer recycled polymer and post-industrial recycled polymer. PCR is typically collected from recycling programs and recycling plants. The PCR may include one or more of a polyethylene, a polypropylene, a polyester, a poly(vinyl chloride), a polystyrene, an acrylonitrile butadiene styrene, a polyamide, an ethylene vinyl alcohol, an ethylene vinyl acetate, or a poly-vinyl chloride. The PCR may include one or more contaminants. The contaminants may be the result of the polymeric material's use prior to being repurposed for reuse. For example, contaminants may include paper, ink, food residue, or other recycled materials in addition to the polymer, which may result from the recycling process. PCR is distinct from virgin polymeric material. A virgin polymeric material (such as a virgin polyethylene resin) does not include materials previously used in a consumer or industry application. Virgin polymeric material has not undergone, or otherwise has not been subject to, a heat process or a molding process, after the initial polymer manufacturing process. The physical, chemical, and flow properties of PCR resins differ when compared to virgin polymeric resin, which in turn can present challenges to incorporating PCR into formulations for commercial use.

As used in the present disclosure, “PCR resin formulation” means a polymer blend comprising the PCR resin, ethylene/alpha-olefin copolymer, high density polyethylene, and optionally other components and additives. In many of the embodiments discussed below, the PCR resin formulation may be its own product (e.g., in a pellet form) or may be further blended with other materials to produce another product, such as a film, sheet, and the like.

As used in the present disclosure, “virgin polyethylene resin formulation” may include virgin polymeric material as described above and may include one or a blend of multiple polyethylene compositions. This blend of multiple polyethylene compositions may a multimodal in-reactor blend or a physical blend of multiple polyethylenes melt blended, dry blended, or the like.

The term “HDPE” or “high density polyethylene” refers to ethylene-based polymers having densities greater than 0.940 g/cc, which are generally prepared with Ziegler-Natta catalysts, chrome catalysts or even metallocene catalysts. For additional clarity, while the HDPE is an ethylene/alpha-olefin copolymer, it is not a lower density ethylene/alpha-olefin copolymer having a density of 0.850 g/cc to 0.910 g/cc as described herein.

In one embodiment, a post-consumer recycled (PCR) resin formulation may comprise a PCR resin and a virgin polyethylene resin formulation. The PCR resin may comprise a blend of polyethylene recovered from post-consumer material. The virgin polyethylene resin formulation may comprise a density from 0.910 to 0.950 g/cc, an improved comonomer content distribution (iCCD) wt. fraction greater than 30 wt. % at a temperature range of 35 to 90° C., and an iCCD wt. fraction greater than 8 wt. % at a temperature range of 99 to 115° C. The iCCD wt. fraction may be defined as a ratio of the mass eluted at temperatures from 35 to 90° C. for the virgin polyethylene resin formulation to the total mass eluted for the virgin polyethylene resin formulation when measured using an iCCD curve of mass eluted versus temperature. The PCR resin formulation may comprise an overall density of from 0.910 to 0.930 g/cc; an iCCD second elution peak occurring at a temperature greater than 99° C.; an iCCD wt. fraction greater than 6 wt. % at a temperature range of 99 to 115° C., and an iCCD wt. fraction greater than 60 wt. % at a temperature range of 35 to 90° C. The iCCD wt. fraction may be defined as a ratio of the mass eluted at temperatures from 99 to 115° C. for the PCR resin formulation to the total mass eluted for the PCR resin formulation when measured using an iCCD curve of mass eluted versus temperature.

Embodiments of the present disclosure are directed to post-consumer recycled resin (PCR) formulations comprising: from 10 wt. % to 75 wt. % of a post-consumer recycled resin (PCR), wherein the PCR resin comprises a differential scanning calorimeter (DSC) second heat of fusion of 120 J/g to 200 J/g. The PCR resin can have a count of defect with an equivalent circular diameter in the range of 200-400 μm (per 24.6 cm³ of film) greater than 500, or greater than 800, or greater than 1000, or greater than 2000. The PCR resin can have a count of defect with an equivalent circular diameter in the range of 400-800 μm (per 24.6 cm³ of film) greater than 250, or greater than 400, or greater than 500, or greater than 1000. A typical virgin resin has a defect count of 200-400 μm (per 24.6 cm³ of film) less than 100 and a defect count of 400-800 μm (per 24.6 cm³ of film) less than 100. PCR polyolefins have a higher defect count due to contamination and because the materials have been made into an article, used, and recovered. The processing means that the material has gone through at least two or at least three prior thermal cycles of heating and cooling.

In some embodiments, these PCR formulations may be in pellet form. These PCR resin formulations, which may be in pellet form, may then be incorporated into a product, such as a film or sheet.

As discussed above, the overall PCR resin formulation may comprise PCR resin and virgin polyethylene resin formulation. The PCR resin and virgin polyethylene resin formulation may be combined by physical mixing, such as by co-extrusion.

In embodiments, the PCR resin formulation may comprise from 10 to 75 wt. % of a PCR resin, based on the total wt. % of the overall PCR resin formulation. All individual values and subranges of from 10 to 75 wt. % are disclosed and included herein; for example, the polymer blend may comprise from 10 to 70 wt. %, from 10 to 75 wt. %, from 15 to 75 wt. %, from 20 to 75 wt. %, from 45 to 75 wt. %, from 50 to 75 wt. %, from 55 to 75 wt. %, from 60 to 75 wt. %, from 65 to 75 wt. %, 10 to wt. %, from 35 to 75 wt. %, from 10 to 60 wt. %, from 20 to 60 wt. %, from 30 to 60 wt. %, from 35 to 60 wt. %, from 40 to 60 wt. %, from 45 to 60 wt. %, from 50 to 60 wt. %, from 55 to 60 wt. %, from 10 to 50 wt. %, from 20 to 50 wt. %, 30 to 50 wt. %, from 35 to 50 wt. %, from 40 to 50 wt. %, from 45 to 50 wt. %, 30 to 40 wt. %, or from 35 to 40 wt. % PCR resin, based on the total wt. % of the overall PCR resin formulation.

The overall PCR resin formulation may comprise from 25 to 90 wt. % of the virgin polyethylene resin formulation, based on the total wt. % of the overall PCR resin formulation. For example, the PCR resin formulation may comprise from 25 to 85 wt. %, from 25 to 75 wt. %, from 25 to 60 wt. %, from 25 to 45 wt. %, from 25 to 30 wt. %, from 30 to 90 wt. %, from 40 to 90 wt. %, from 40 to 75 wt. %, from 40 to 60 wt. %, from 40 to 50 wt. %, from 55 to 90 wt. %, from 55 to 75 wt. %, from 70 to 90 wt. %, or any subset thereof, of the virgin polyethylene resin.

The PCR resin formulation may comprise an overall density of from 0.910 to 0.950 g/cc, based on the weight of the overall PCR resin formulation. For example, the PCR resin formulation may comprise an overall density of from 0.910 to 0.940 g/cc, from 0.910 to 0.925 g/cc, from 0.910 to 0.920 g/cc, from 0.910 to 0.915 g/cc, from 0.915 to 0.930 g/cc, from 0.915 to 0.925 g/cc, from 0.915 to 0.920 g/cc, from 0.920 to 0.930, from 0.920 to 0.925 g/cc, from 0.915 to 0.925 g/cc, or any subset thereof.

The PCR resin formulation may comprise an iCCD second elution peak occurring at a temperature greater than 99° C. For example, the PCR resin formulation may comprise an iCCD second elution peak occurring at a temperature greater than 100° C., great than 102° C., greater than 104° C., greater than 106° C., greater than 108° C., greater than 110° C., from 99 to 120° C., from 99 to 110° C., or any subset thereof.

The PCR resin formulation may comprise an iCCD wt. fraction greater than 6 wt. % at a temperature range of 99 to 115° C. For example, the PCR resin formulation may comprise an iCCD wt. fraction greater than 8 wt. %, greater than 10 wt. %, greater than 12 wt. %, greater than 15 wt. %, from 8 to 30 wt. %, from 8 to 25 wt. %, from 8 to 20 wt. %, from 8 to 15 wt. %, or any subset thereof, at a temperature range of 99 to 115° C. The iCCD wt. fraction may be defined as a ratio of the mass eluted at temperatures from 99 to 115° C. for the PCR resin formulation to the total mass eluted for the PCR resin formulation when measured using an iCCD curve of mass eluted versus temperature.

The PCR resin formulation may comprise an iCCD wt. fraction greater than 60 wt. % at a temperature range of 35 to 90° C. For example, the PCR resin formulation may comprise an iCCD wt. fraction greater than 65 wt. %, greater than 70 wt. %, greater than 75 wt. %, greater than 80 wt. %, greater than 85 wt. %, from 60 to 90 wt. %, from 60 to 85 wt. %, from 60 to 80 wt. %, from 60 to 75 wt. %, from 60 to 70 wt. %, from 65 to 90 wt. %, or any subset thereof. The iCCD wt. fraction may be defined as a ratio of the mass eluted at temperatures from 35 to 90° C. for the PCR resin formulation to the total mass eluted for the PCR resin formulation when measured using an iCCD curve of mass eluted versus temperature.

The PCR resin formulation may also have a melt index (I₂) of 0.1 to 2 g/10 mins. In further embodiments, the 12 may be from 0.1 to 1.0, from 0.1 to 0.75, from 1.0 to 2.0 g/10 mins, 1.0 to 1.75 g/10 mins, or any subset thereof. The PCR resin formulation may also have a melt index (I₁₀) of 1 to 15 g/10 mins, or from 1 to 10 g/10 mins, or from 1 to 5 g/10 mins, from 10 to 15 g/10 mins, or any subset thereof.

### PCR Resin

It is contemplated that the PCR includes various compositions. PCR may be sourced from LDPE/LLDPE packaging such as films. PCR also includes residue from its original use, residue such as paper, adhesive, ink, nylon, ethylene vinyl alcohol (EVOH), polyethylene terephthalate (PET), and other odor-causing agents.

In embodiments, the PCR resin comprises polyethylene, such as low density polyethylene, linear low density polyethylene, or a combination thereof. In embodiments, the PCR further comprises residue from its original use, such as paper, adhesive, ink, nylon, ethylene vinyl alcohol (EVOH), polyamide (PA), polyethylene terephthalate (PET), and other organic or inorganic material. Examples of PCR include AVANGARD™ NATURA PCR-LDPCR-100 (“AVANGARD™ 100”) and AVANGARD™ NATURA PCR-LDPCR-150 (“AVANGARD™ 150”) (PCR commercially available from Avangard Innovative LP, Houston, Texas).

In embodiments, the PCR resin may have a density of 0.900 to 0.940 g/cc and a melt index 12 from 0.5 to 6 g/10 min when measured at 190° C. and 2.16 kg. For example, the PCR resin may have a density of from 0.900 to 0.940 g/cc, from 0.900 to 0.930 g/cc, from 0.900 to 0.920 g/cc, from 0.900 to 0.910 g/cc, from 0.910 to 0.940 g/cc, from 0.920 to 0.940 g/cc, from 0.930 to 0.940 g/cc, from 0.910 to 0.930, from 0.920 to 0.930, or any subset thereof; and a melt index 12 of from 0.5 to 6 g/10 min, from 1 to 6 g/10 min, from 2 to 6 g/10 min, from 3 to 6 g/10 min, from 4 to 6 g/10 min, from 5 to 6 g/10 min, from 0.5 to 5 g/10 min, from 0.5 to 4 g/10 min, from 0.5 to 3 g/10 min, from 0.5 to 2 g/10 min, from 0.5 to 1 g/10 min, from 1 to 5 g/10 min, from 2 to 4 g/10 min, or any subset thereof.

The PCR resin may have a differential scanning calorimeter (DSC) second heat of fusion of 120 J/g to 200 J/g, when measured according to the DSC test method described below. For example, the PCR resin may have a DSC second heat of fusion of 120 J/g to 200 J/g, of 120 J/g to 180 J/g, 120 J/g to 160 J/g, 120 J/g to 140 J/g, 140 J/g to 200 J/g, 140 J/g to 200 J/g, 140 J/g to 180 J/g, 140 J/g to 160 J/g, 160 J/g to 200 J/g, 160 J/g to 200 J/g, 160 J/g to 180 J/g, 180 J/g to 200 J/g, 180 J/g to 200 J/g, or any subset thereof.

In embodiments, the PCR resin has a peak melting temperature (Tm) of from 105 to 127° C., when measured according to the DSC test method describe below. All individual values and subranges of from 105° C. to 127° C. are disclosed and incorporated herein; for example, the peak melting temperature (Tm) of the PCR can be from 105 to 125° C., 107 to 125° C., 109 to 125° C., 111 to 125° C., 113 to 125° C., 115 to 125° C., 117to 125,105 to 123° C., 107to 123° C., 109to 123° C., 111 to 123° C., 113 to 123° C., 115 to 123° C., 117to 123° C., 119to 123° C., 121 to 123° C., 119 to 127° C., 119 to 125° C., 119 to 123° C., 119 to 121° C., 121 to 125° C., 123 to 127° C., 123 to 125° C., or 125 to 127° C., when measured according to the DSC test method described below.

The PCR resin may have a count of defect with an equivalent circular diameter in the range of 200-400 μm (per 24.6 cm³ of film) greater than 500, or greater than 800, or greater than 1000, or greater than 2000. The PCR resin may have a count of defect with an equivalent circular diameter in the range of 400-800 μm (per 24.6 cm³ of film) greater than 250, or greater than 400, or greater than 500, or greater than 1000. In contrast, a typical virgin resin has a defect count of 200-400 μm (per 24.6 cm³ of film) less than 100 and a defect count of 400-800 μm (per 24.6 cm³ of film) less than 100. PCR resins have a higher defect count due to contamination and because the materials have been made into an article, used, and recovered. The processing means that the material has gone through at least two or at least three prior thermal cycles of heating and cooling

### Virgin Polyethylene Resin Formulation

As discussed above, the PCR resin formulation may include a virgin polyethylene resin formulation. The virgin polyethylene resin formulation may have a density of from 0.910 to 0.950 g/cc. For example, the virgin polyethylene resin may have a density of from 0.910 to 0.940 g/cc, 0.910 to 0.930 g/cc, 0.910 to 0.920 g/cc, from 0.910 to 0.915 g/cc, from 0.915 to 0.925 g/cc, from 0.915 to 0.920 g/cc, from 0.920 to 0.925 g/cc, or any subset thereof.

The virgin polyethylene resin may have an improved comonomer content distribution (iCCD) wt. fraction greater than 30 wt. % at a temperature range of 35 to 90° C. For example the virgin polyethylene resin may have an iCCD wt. fraction greater than 35 wt. %, greater than 40 wt. %, greater than 45 wt. %, greater than 50 wt. %, greater than 55 wt. %, greater than 60 wt. %, greater than 65 wt. %, greater than 70 wt. %, greater than 75 wt. %, greater than 80 wt. %, greater than 85 wt. %, from 60 to 90 wt. %, from 60 to 85 wt. %, from 60 to 80 wt. %, from 60 to 75 wt. %, from 60 to 70 wt. %, from 65 to 90 wt. %, or any subset thereof. The iCCD wt. fraction at a temperature range of 35 to 90° C. may be defined as a ratio of the mass eluted at temperatures from 35° C. to 90° C. for the virgin polyethylene resin to the total mass eluted for the virgin polyethylene resin when measured using an iCCD curve of mass eluted versus temperature.

The virgin polyethylene resin may have an iCCD wt. fraction greater than 8 wt. % at a temperature range of 99 to 115° C. For example, the virgin polyethylene resin may have an iCCD wt. fraction greater than 10 wt. %, greater than 12 wt. %, greater than 15 wt. %, greater than 20 wt. %, greater than 25 wt. %, greater than 30 wt. %, greater than 35 wt. %, greater than 40 wt. %, greater than 50 wt. %, from 8 wt. % to 90 wt. %, from 8 wt. % to 40 wt. %, from 8 wt. % to 30 wt. %, from 8 wt. % to 20 wt. %, from 10 wt. % to 40 wt. %, from 15 wt. % to 30 wt. %, or any subset thereof. The iCCD wt. fraction at a temperature range of 99 to 115° C. may be defined as a ratio of the mass eluted at temperatures from 99 to 115° C. for the virgin polyethylene resin to the total mass eluted for the virgin polyethylene resin when measured using an iCCD curve of mass eluted versus temperature.

The virgin polyethylene resin formulation may comprise a blend of ethylene/alpha-olefin copolymer and a high density polyethylene (HDPE) resin. The blend may be a physical blend or an in-reactor bimodal blend. A physical blend of the ethylene/alpha-olefin and HDPE may be prepared by physically mixing the two components, such as by co-extrusion or dry blending. An in-reactor bimodal blend may be prepared by producing the two components in a single reactor, such as through the inclusion of two distinct catalysts.

As stated above, the ethylene-alpha olefin copolymer of the virgin polyethylene resin formulation is a virgin polymer that does not include materials previously used in a consumer or industry application. The ethylene-alpha olefin copolymer may be a copolymer of ethylene and at least one C₃-C₁₂ alpha-olefin comonomer. In one or more embodiments, the alpha-olefin comonomer is selected from hexene or octene. The virgin ethylene-alpha olefin copolymer may comprise linear low-density polyethylene (LLDPE).

In one embodiment, the ethylene/alpha-olefin copolymer may have a density of 0.890 to 0.930 g/cc, or from 0.890 to 0.915 g/cc. Moreover, the first ethylene/alpha-olefin copolymer (for example, the LLDPE) may have a melt index (I₂) of less than 2 g/10 mins, such as less than 1.5 g/10 min, less than 1 g/10 min, from 0.2 to 2.0 g/10 mins, from 0.5 to 1.5 g/10 mins, from 0.5 to 2 g/10 min, 0.2 to 1.5 g/10 mins, or any subset thereof, when measured at 190° C. and 2.16 kg.

### HDPE

In one or more embodiments, the HDPE may form a part of the virgin polyethylene resin. Accordingly, the HDPE may be a virgin polymer that does not include materials previously used in a consumer or industry application

The HDPE, which may be considered the second ethylene/alpha-olefin copolymer, may have a density of greater than 0.950 g/cc, such as from 0.950 g/cc to 0.975 g/cc, or from 0.955 g/cc to 0.965 g/cc. Moreover, the HDPE may have a melt index (I₂) of 0.1 to 2 g/10 mins, or from 0.2 to 1 g/10 mins as measured according to ASTM D1238 (190° C./2.16 kg). Various amounts of the HDPE are contemplated as suitable. In one embodiment, the PCR resin formulation may comprise from 5 to 25 wt. % HDPE.

### Other Components of the Polymer Blend

In further embodiments, the PCR resin formulation can comprise further components, such as, one or more additives. Potential additives include, but are not limited to, antistatic agents, color enhancers, dyes, lubricants, fillers, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. The polymer blend can contain from 0.01 or 0.1 or 1 to 5, 10, 15 wt. % of such additives, based on the total weight of the polymer blend.

As stated previously, the PCR resin formulation may be incorporated into various products. In one embodiment, this product may be a pellet.

### Films

In further embodiments, the PCR resin formulation may be incorporated into at least one layer of a film. The film may be a monolayer or multilayer film. Useful films according to embodiments of the present disclosure include cast, blown, and calendered (including multi-layer films, greenhouse films, shrink films including clarity shrink film, lamination film, biaxially-oriented film, extrusion coating, liners, clarity liners, overwrap film and agricultural film). Monolayer and multilayer films may be made according to the film and fabrication methods described in U.S. Pat. No. 5,685,128.

When formed into a film, the PCR resin formulation of the present disclosure can be a more sustainable way of producing a film, and can also provide a number of other advantages. For example, while providing a sustainable formulation for forming a film, the films, in some embodiments of the present disclosure, maintain or minimize the reduction of films properties such as elastic recovery, toughness, stiffness, or photodegradability. The advantages of a sustainable film with effective performance provides alternatives to existing film structures where, for example, balance of toughness with stiffness is a desired property.

In embodiments, the film formed from the polymer blend has a thickness in the range of from 0.5 to 20 mils. All individual values and subranges of from 0.5 to 20 mils are disclosed and included herein; for example, the film formed from the polymer blend can have a thickness of from 1 to 20 mils, from 1 to 18 mils, from 1 to 16 mils, from 1 to 14 mils, from 1 to 12 mils, from 1 to 10 mils, from 1 to 8 mils, from 1 to 6 mils, 5 to 20 mils, from 5 to 18 mils, from 5 to 16 mils, from 5 to 14 mils, from 5 to 12 mils, from 5 to 10 mils, from 5 to 8 mils, from 5 to 6 mils, from 8 to 20 mils, from 8 to 18 mils, from 8 to 16 mils, from 8 to 14 mils, from 8 to 12 mils, from 8 to 10 mils, from 10 to 20 mils, from 10 to 18 mils, from 10 to 16 mils, from 10 to 14 mils, from 10 to 12 mils, from 12 to 20 mills, from 12 to 18 mils, from 12 to 16 mils, from 12 to 14 mils, from 14 to 20 mils, from 14 to 18 mils, from 14 to 16 mils, from 16 to 20 mils, from 16 to 18 mils, or from 18 to 20 mils.

In embodiments, the film is a monolayer film. In such embodiments, the components of the polymer blend are blended with one another and optional other components (e.g., other polymers or additives) in any conventional manner (e.g., dry blending, in reactor mixing, or compounding) and subsequently melt mixing either directly in the extruder to make the film or pre-melt mixing in a separate extruder, and fabricating into a film using any film producing process, such as blown film or cast film.

The films according to embodiments of the present disclosure have many utilities and can be formed into a variety of articles. For examples, the films according to embodiments of the present disclosure can be over-wrapping films such as tissue over-wraps, bundled bottled water over-wraps; clarity films such as candy bags, bread bags, envelope window films; food and specialty packaging films, such as produce bags, meat wraps, cheese wraps, beverage holders; and pouches such as milk pouches or bags-in-box such as wine.

As noted above, the films of this invention may be made by conventional fabrication techniques, e.g., simple bubble extrusion, biaxial orientation processes (such as tenter frames or double bubble processes), simple cast/sheet extrusion, co-extrusion, lamination, etc.

Extrusion coating is another technique for producing films. Similar to cast film, extrusion coating is a flat die technique. A film can be extrusion coated or laminated onto a substrate either in the form of a monolayer or a coextruded film.

### Test Methods

### Density

Density is measured in accordance with ASTM D792, and expressed in grams/cm³ (g/cm³).

Melt Indices (I₂, I₁₀, and I₂₁)

Melt Index (I₂) is measured in accordance with ASTM D 1238-10 at 190 Celsius and 2.16 kg, Method B, and is expressed in grams eluted/10 minutes (g/10 min).

Melt Index (I₁₀) is measured in accordance with ASTM D 1238-10 at 190 Celsius and 10 kg, Method B, and is expressed in grams eluted/10 minutes (g/10 min).

Melt Index (I₂₁) is measured in accordance with ASTM D 1238-10 at 190 Celsius and 21.6 kg, Method B, and is expressed in grams eluted/10 minutes (g/10 min).

### DSC Method

Differential scanning calorimetry (DSC) is a common technique that can be used to examine the melting and crystallization of semi-crystalline polymers. General principles of DSC measurements and applications of DSC to studying semi-crystalline polymers are described in standard texts (e.g., E. A. Turi, ed., Thermal Characterization of Polymeric Materials, Academic Press, 1981).

In preparation for Differential Scanning Calorimetry (DSC) testing, pellet-form samples are first loaded into a 1 in. diameter chase of 0.13 mm thickness and compression molded into a film under 25,000 lbs of pressure at 190° C. for approximately 10 seconds. The resulting film is then cooled to room temperature. After which, the film is subjected to a punch press in order to extract a disk that will fit the DSC test pan (Aluminum Tzero). The disk is then weighed individually (note: sample weight is approximately 5-6 mg) and placed into the aluminum Tzero pan and sealed before being inserted into the DSC test chamber.

In accordance to ASTM standard D3418, the DSC test is conducted using a heat-cool-heat cycle. First, the sample is equilibrated at 180° C. and held isothermally for 5 min to remove thermal and process history. The sample is then quenched to −40° C. at a rate of 10° C./min and held isothermally once again for 5 min during the cool cycle. Lastly, the sample is heated at a rate of 10° C./min to 150° C. for the second heating cycle. For data analysis, the melting temperatures and enthalpy of fusion is extracted from the second heating curve, whereas the enthalpy of crystallization is taken from the cooling curve. The enthalpy of fusion and crystallization were obtained by integrating the DSC thermogram from −20° C. to the end of melting and crystallization, respectively. The tests were performed using the TA Instruments Q2000 and Discovery DSCs, and data analyses were conducted via TA Instruments Universal Analysis and TRIOS software packages.

Improved Method for Comonomer Content Distribution (iCCD) Analysis

Improved method for comonomer content distribution (iCCD) analysis was, developed in 2015 (Cong and Parrott et al., WO2017040127A1), performed with Crystallization Elution Fractionation instrumentation (CEF) (PolymerChar, Spain) equipped with a IR-5 detector (PolymerChar, Spain) and two angle light scattering detector Model 2040 (Precision Detectors, currently Agilent Technologies). Ortho-dichlorobenzene (ODCB, 99% anhydrous grade or technical grade) was used. Silica gel 40 (particle size 0.2˜0.5 mm, catalogue number 10181-3) from EMD Chemicals was obtained (can be used to pack into columns to further purify ODCB, the packed columns are installed after outlet of Agilent pump). The CEF instrument is equipped with an autosampler with N2 purging capability. ODCB is sparged with dried nitrogen (N2) for one hour before use. Sample preparation was done with autosampler at 4 mg/mL (unless otherwise specified) under shaking at 160° C. for 1 hour. The injection volume was 300 μL. The temperature profile of iCCD was: crystallization at 3° C./min from 105° C. to 30° C., the thermal equilibrium at 30° C. for 2 minute (including Soluble Fraction Elution Time being set as 2 minutes), and elution at 3° C./min from 30° C. to 140° C. The flow rate during crystallization is 0.0 mL/min. The flow rate during elution is 0.50 mL/min. The data was collected at one data point/second.

The iCCD column was packed with gold coated nickel particles (Bright 7GNM8-NiS, Nippon Chemical Industrial Co.) in a 15 cm (length) by 1/4″ (ID) (0.635 cm) stainless tubing. The column packing and conditioning were with a slurry method according to the reference (Cong, R.; Parrott, A.; Hollis, C.; Cheatham, M., US Publication US20180172648A1). The final pressure with TCB slurry packing was 150 Bars.

Column temperature calibration was performed by using a mixture of the Reference Material Linear homopolymer polyethylene (having zero comonomer content, Melt index (I₂) of 1.0, polydispersity Mw/Mn approximately 2.6 by conventional gel permeation chromatography, 1.0 mg/mL) and Eicosane (2 mg/mL) in ODCB. The iCCD temperature calibration consisted of four steps: (1) Calculating the delay volume defined as the temperature offset between the measured peak elution temperature of Eicosane minus 30.00° C.; (2) Subtracting the temperature offset of the elution temperature from the iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min according to the reference (US20180172648A1).

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000 g/mol). All of these reference materials were analyzed in the same way as specified previously at 4 mg/mL. The modeling of the reported elution peak temperatures as a function of octene mole % using linear regression resulted in the following equation for which R² was 0.978. The elution peak is the temperature with the highest weight fraction eluting.

(Elution Temperature in Degrees C.)=−6.3515(comonomer Mol %)+101.000

### Dart

The Dart Drop test follows ASTM D1709 and provides a measure of the energy needed to cause a plastic film to fail under specified conditions of impact by a free falling dart. The test result is the energy, expressed in terms of the weight of the missile falling from a specified height, which would result in the failure of 50% of the specimens tested. The film sample is conditioned for at least 40 hours at 23° C. (2° C.) and 50% R.H (±10%) before the test which is conducted at 23° C. (2° C.) and 50% R.H (±10%). Method-A, which uses a 1.5″ diameter dart head and 26″ drop height, was employed for the current film samples. The material of construction of Dart head is Aluminum. The sample thickness is measured at the sample center and the sample is then clamped by an annular specimen holder with an inside diameter of 5″. The dart is loaded above the center of the sample and released by either a pneumatic or an electromagnetic mechanism. The Dart is loaded with a starting weight which is subsequently either increased or decreased by a chosen weight depending on pass/fail from each drop. About 20-25 specimens are typically used for the drop experiments. Finally, a staircase method as per ASTM D1709 is employed to calculate the ‘Dart’ value based on the collection of pass/fail data, the starting weight and the weight increment.

### Instrumented Dart Impact Test

Instrumented dart impact (IDI) testing follows and is compliant with ASTM D7192. The probe used is stainless steel, polished to a mirror finish, striking the film at 3.3 m/s. Force versus displacement curves, peak force, peak energy, displacement and total energy are reported.

### Secant Modulus

Secant modulus was measured as described here. The film sample is conditioned for at least 40 hours at 23° C. (±2° C.) and 50% R.H (±10%) before the test which is conducted at 23° C. (2° C.) and 50% R.H (±10%). Film strips of dimension 1″ wide by 8″ long are cut from a film in the desired direction (machine (MD) and the cross directions (CD)). The specimens are loaded onto a tensile testing frame using line grip jaws (flat rubber on one side of the jaw and a line grip on the other) set at a gauge length of 4″. The specimens are then strained at a crosshead speed of 2 in./min up to a nominal strain of 5%. The secant modulus is measured at a specified strain and is the ratio of the stress at the specified strain to the specified strain, as determined from the load—extension curve. Typically, secant modulus at 10% and 2% strain are calculated. Five replicates are typically tested for each sample.

### Defect Count

The Defect Count is a measure of defects that are detected in an extruded film using optical imaging technology according the practices and guidance in ASTM D7310-20 “Standard Practice for Defect Detection and Rating of Plastic Film Using Optical Sensors.” The Defect Count is reported as the number of optical defects per 24.6 cm³ with an effective circular diameter within defined series of ranges: 200-400 μm, 400-800 μm, 800-1600 μm, 1600 μm and above. It is measured by an Optical Control Systems Film Surface Analyzer FSA100 (OCS FSA100) optical imaging system. The OCS FSA100 optical imaging system consists of a lighting unit, a CCD line scan camera, and a computer with image/data analysis software version 5.0.4.6.

The OCS FSA100 optical imaging system detects defects as they obscure the transmission of halogen-based source light. Average greyscale was set to 170 with a threshold sensitivity setting of 35%. Additionally, the gain of the CCD system may be adjusted to compensate for film haziness. The imaging system creates a composite area of each defect by adding the defective pixels from each subsequent line scan. The system then reports the number of defects which were in user defined size ranges, based on the diameter of circles having equivalent areas.

Film fabrication is accomplished by an OCS ME19 cast film extrusion system equipped with a fixed lip coat hanger die. Die gap is 500 μm by 15 cm. It is a single screw extruder equipped with a 19 mm screw provided by OCS. The screw design is a 3:1 L/D compression ratio with a pineapple mixing tip. Total extrusion system mass output is 10±5 kg/hour. Film thickness was 38 μm, which was achieved via adjustment of the chill roll. A nitrogen purge was used at the feed throat of the extruder. Temperature profiles ranged from 135° C.-190° C. to achieve a target extrusion pressure of 220-240Bar.

PCR resin was analyzed neat unless it was not possible to be extruded at 100% on the OCS system. If the PCR resin could not be processed neat it was diluted (50/50 Wt %) with virgin PE material in dry blend prior to extrusion. The virgin polyethylene used for dilution was an LDPE with a melt index in the range of 0.2-1 g/10 min (190° C.), and a density in the range of 0.919-0.923 g/cm³. (e.g. DOW Polyethylene 132I Low Density, hereafter referred to as LDPE 132I).

### EXAMPLES

The following examples illustrate one or more features of the PCR resin formulations of the present disclosure.

NATURA PCR-LDPCR-100/200 (hereafter referred to as AV100) from Avangard Innovative was used for the PCR resin. The Melt Index 12(190° C.) of AV100 is 1.8-2.8 g/10 min and the density is 0.910-0.925 g/cm³. According to DSC analysis, the 2^{nd} heat of fusion is 141.05 J/g with a standard deviation of 4.25 J/g. Based on defect count, AV100 has a defect count in the 200-400 μm range of greater than 500 per 24.6 cm³ of film and a defect count in 400-800 μm range of greater than 250 per 24.6 cm³ of film.

The following materials listed in Table 1 are used in the examples.

TABLE 1
Virgin resins

| | | | Melt Index |
|---|---|---|---|
| | | Density | (I₂) (g/10 |
| Product Name | Component Type | (g/cc) | mins) |
| XUS 60911.06 | Ethylene/alpha olefin copolymer | 0.917 | 0.9 |
| | (LLDPE) | | |
| DOWLEX ™ GM 8070G | Ethylene/alpha olefin copolymer | 0.917 | 0.9 |
| | (LLDPE) | | |
| DOWLEX ™ 2020G | Ethylene/alpha olefin copolymer | 0.920 | 0.5 |
| | (LLDPE) | | |
| XUS 59999.31 | Ethylene/alpha olefin copolymer | 0.905 | 0.5 |
| INNATE ™ ST 50 | Ethylene/alpha olefin copolymer | 0.918 | 0.85 |
| UNIVAL ™ DMDA-6400 NT 7 | HDPE | 0.961 | 0.80 |
| Example Resin 1 | Ethylene/alpha olefin copolymer | 0.919 | 0.17 |
| Example Resin 2 | Ethylene/alpha olefin copolymer | 0.908 | 0.17 |
| Example Resin 3 | Ethylene/alpha olefin copolymer | 0.919 | 0.27 |
| Example Resin 4 | Ethylene/alpha olefin copolymer | 0.908 | 0.32 |
| Example Resin 5 | Ethylene/alpha olefin copolymer | 0.911 | 0.52 |
| Example Resin 6 | Ethylene/alpha olefin copolymer | 0.919 | 0.61 |
| Example Resin 7 | Ethylene/alpha olefin copolymer | 0.919 | 0.27 |
| Example Resin 8 | Ethylene/alpha olefin copolymer | 0.918 | 0.85 |
| | (LLDPE) | | |

For Example Resins 1-4, XCAT™ HP-100 catalyst (obtained from Univation Technologies, LLC, Houston, Texas) was utilized. For Example Resins 5-7, XCAT™ VP-100 catalyst (obtained from Univation Technologies, LLC, Houston, Texas) was utilized.

For Example Resins 1 and 2, a hydrogenation catalyst was used during the polymerization. Hydrogenation catalyst-1 (titanocene catalyst) was prepared as follows: a 1 L bottle was charged with 15.1 g of bis(cyclopentadienyl)titanium dichloride (Sigma-Aldrich), 527 mL of hexane, and a stir bar to form a suspended mixture. To this mixture, 60.3 g of triisobutylaluminum (neat, Sigma-Aldrich) was slowly add over 10 minutes while stirring. The solid Cp₂TiCl₂ became soluble and formed a blue solution which was further diluted with isopentane to provide a 0.3 weight percent mixture. During the subsequent polymerization, XCAT™ HP-100 and hydrogenation catalyst-1 were separately fed into a gas-phase reactor to make a zirconocene/titanocene catalyst system in situ; the XCAT™ HP-100 was fed dry using nitrogen as carrier, and hydrogenation catalyst-1 was fed as liquid catalyst solution in isopentane. Then, ethylene was copolymerized with 1-hexene in the gas-phase reactor. The polymerization was continuously conducted after equilibrium was reached under conditions set forth in Table 2.

Example Resins 3 and 4 were made without use of hydrogenation catalyst. XCAT™ HP-100 was fed into a gas-phase reactor using nitrogen as the carrier gas. Ethylene was copolymerized with 1-hexene in the gas-phase reactor and the polymerization was continuously conducted after equilibrium was reached under conditions set forth in Table 2.

TABLE 2
Process Conditions for Example Resins 1-4

| | Example | Example | Example | Example |
|---|---|---|---|---|
| | Resin 1 | Resin 2 | Resin 3 | Resin 4 |
| Reactor | 85 | 75 | 85 | 75 |
| Temperature | | | | |
| (° C.) | | | | |
| Reactor | 378 | 378 | 378 | 377 |
| Pressure | | | | |
| (psig) | | | | |
| C₂ partial | 200 | 201 | 200 | 201 |
| pressure | | | | |
| (psi) | | | | |
| H₂ to C₂ ratio | 0.00007 | 0.00008 | 0.00012 | 0.00016 |
| (mol/mol) | | | | |
| C₆ to C₂ ratio | 0.017 | 0.034 | 0.022 | 0.034 |
| (mol/mol) | | | | |
| Isopentane | 4.99 | 3.00 | 4.94 | 2.99 |
| (mol %) | | | | |
| C₂ feed rate | 40.7 | 26.9 | 35.5 | 33.5 |
| (lb/hr) | | | | |
| C₆ feed rate | 1.949 | 2.727 | 2.129 | 3.713 |
| (lb/hr) | | | | |
| H₂ feed rate | 0 | 0 | 0 | 0 |
| (millipound/hr) | | | | |
| Zr feed rate | 0.027 | 0.049 | 0.014 | 0.024 |
| (from | | | | |
| zirconocene | | | | |
| g/hr) | | | | |
| Titanocene | 107.7 | 26.1 | — | — |
| solution feed | | | | |
| rate | | | | |
| (cm³/hr) | | | | |
| Titanium to | 0.445 | 0.210 | — | — |
| zirconium | | | | |
| (molar ratio) | | | | |
| Production rate | 34.3 | 20.7 | 30.3 | 30.0 |
| (lb/hr) | | | | |
| Bed weight | 156 | 198 | 152 | 195 |
| (lbs) | | | | |
| MI₂ | 0.17 | 0.17 | 0.27 | 0.32 |
| Density | 0.919 | 0.908 | 0.919 | 0.908 |

Example, Resins 5-7 were made using XCAT™ VP-100 catalyst. XCAT™ Vp-10 was fed into a gas-phase reactor using nitrogen as the carrier gas. Ethylene was copolymerized with 1-hexene in the gas-phase reactor and the polymerization was continuously conducted after equilibrium was reached under conditions set forth in Table 3.

TABLE 3
Process Conditions for Example Resins 5-7

| | Example | Example | Example |
|---|---|---|---|
| | Resin 5 | Resin 6 | Resin 7 |
| Reactor | 72.6 | 75.8 | 77.0 |
| Temperature | | | |
| (° C.) | | | |
| Reactor | 348 | 349 | 349 |
| Pressure | | | |
| (psig) | | | |
| C₂ partial | 200 | 190 | 190 |
| pressure | | | |
| (psi) | | | |
| H₂ to C₂ ratio | 0.00055 | 0.00043 | 0.00032 |
| (mol/mol) | | | |
| C₆ to C₂ ratio | 0.0174 | 0.0150 | 0.0145 |
| (mol/mol) | | | |
| Isopentane | 4.95 | 8.02 | 8.07 |
| (mol %) | | | |
| Production rate | 49.0 | 64.0 | 57.1 |
| (lb/hr) | | | |
| Bed weight | 126 | 146 | 157 |
| (lbs) | | | |
| MI2 | 0.53 | 0.61 | 0.30 |
| MFR I₂₁/I₂ | 40.25 | 27.1 | 25.6 |
| Density | 0.911 | 0.918 | 0.918 |

### Synthesis of Example Resin 8

To make Example Resin 8, all raw materials (monomer and comonomer) and the process solvent (a narrow boiling range high-purity isoparaffinic solvent, Isopar-E) are purified with molecular sieves before introduction into the reaction environment. Hydrogen was supplied pressurized as a high purity grade and is not further purified. The reactor monomer feed stream was pressurized via a mechanical compressor to above reaction pressure. The solvent and comonomer feed was pressurized via a pump to above reaction pressure. The individual catalyst components were manually batch diluted with purified solvent and pressured to above reaction pressure. All reaction feed flows were measured with mass flow meters and independently controlled with computer automated valve control systems.

A two reactor system was used in a parallel configuration. The first reactor was a continuous solution polymerization reactor consisting of a liquid full, non-adiabatic, isothermal, circulating, loop reactor, which mimics a continuously stirred tank reactor (CSTR) with heat removal. Independent control of all fresh solvent, monomer, comonomer, hydrogen, and catalyst component feeds was possible. The total fresh feed stream to the first reactor (solvent, monomer, comonomer, and hydrogen) was temperature controlled to maintain a single solution phase by passing the feed stream through a heat exchanger. The total fresh feed to the first polymerization reactor was injected into the reactor at two locations with approximately equal reactor volumes between each injection location. The fresh feed was controlled with each injector receiving half of the total fresh feed mass flow. The catalyst components were injected into the polymerization reactor separate from the fresh feeds. The primary catalyst component feed was computer controlled to maintain the reactor monomer conversion at the specified value. The cocatalyst components were fed based on molar ratios to the primary catalyst component. Immediately following each first reactor feed injection location, the feed streams were mixed with the circulating polymerization reactor contents with static mixing elements. The contents of the first reactor were continuously circulated through heat exchangers responsible for removing much of the heat of reaction and with the temperature of the coolant side responsible for maintaining an isothermal reaction environment at the specified temperature. Circulation around the first reactor loop was provided by a pump.

The second reactor was a continuous solution polymerization reactor consisting of a liquid full, adiabatic, continuously stirred tank reactor (CSTR). Independent control of all fresh solvent, monomer, comonomer, hydrogen, and catalyst component feeds was possible. The total fresh feed stream to the second reactor (solvent, monomer, comonomer, and hydrogen) was temperature controlled to maintain a single solution phase by passing the feed stream through a heat exchanger. The total fresh feed to the second polymerization reactor was injected into the reactor at one location. The catalyst components was injected into the second polymerization reactor separate from the fresh feed. The primary catalyst component feed was computer controlled to maintain the reactor monomer conversion at the specified value. The cocatalyst components was fed based on molar ratios to the primary catalyst component. Mixing of the second reactor was provided by an agitator.

The effluent from the first polymerization reactor (containing solvent, monomer, comonomer, hydrogen, catalyst components, and polymer) exited the first reactor loop and was combined with the effluent from the second polymerization reactor (also containing solvent, monomer, comonomer, hydrogen, catalyst components, and polymer) where the combined stream then entered a zone where it is deactivated with the addition of and reaction with a suitable reagent (water). Antioxidant addition occurs at this same addition point. Following catalyst deactivation and additive addition, the combined reactor effluent enters a devolatization system where the polymer was removed from the non-polymer stream. The isolated polymer melt was pelletized and collected. The non-polymer stream passed through various pieces of equipment which separate most of the ethylene which is removed from the system. Most of the solvent and unreacted comonomer is recycled back to the reactor after passing through a purification system. A small amount of solvent and comonomer is purged from the process. The process conditions for Example Resin 8 are provided in Table 4.

TABLE 4
Process Conditions for Example Resin 8

| Reactor Configuration | Type | Dual Parallel |
|---|---|---|
| Comonomer type | Type | 1-octene |
| First Reactor Feed Solvent/Ethylene Mass Flow Ratio | g/g | 5.6 |
| First Reactor Feed Comonomer/Ethylene Mass Flow Ratio | g/g | 0.33 |
| First Reactor Feed Hydrogen/Ethylene Mass Flow Ratio | g/g | 3.7E−04 |
| First Reactor Temperature | ° C. | 130 |
| First Reactor Pressure | barg | 41 |
| First Reactor Ethylene Conversion | % | 88.4 |
| First Reactor Catalyst Type | Type | Catalyst component 1 |
| | | (Table 6 below) |
| First Reactor Co-Catalyst 1 Type | Type | Co-catalyst 1 |
| | | (Table 6 below) |
| First Reactor Co-Catalyst 2 Type | Type | Co-catalyst 2 |
| | | (Table 6 below) |
| First Reactor Co-Catalyst 1 to Catalyst Molar Ratio | Ratio | 2.3 |
| (B to Catalyst Metal ratio) | | |
| First Reactor Co-Catalyst 2 to Catalyst Molar Ratio | Ratio | 69.9 |
| (Al to Catalyst Metal ratio) | | |
| First Reactor Residence Time | min | 14.9 |
| Percentage of Total Ethylene Feed to First Reactor | wt % | 60.4% |
| Second Reactor Feed Solvent/Ethylene Mass Flow Ratio | g/g | 5.7 |
| Second Reactor Feed Comonomer/Ethylene Mass Flow Ratio | g/g | 0.133 |
| Second Reactor Feed Hydrogen/Ethylene Mass Flow Ratio | g/g | 2.2E−04 |
| Second Reactor Temperature | ° C. | 204 |
| Second Reactor Pressure | barg | 41 |
| Second Reactor Ethylene Conversion | % | 88.5 |
| Second Reactor Catalyst Type | Type | Catalyst Component 2 |
| | | (Table 6 below) |
| Second Reactor Co-Catalyst 1 Type | Type | Co-catalyst 1 |
| | | (Table 6 below) |
| Second Reactor Co-Catalyst 2 Type | Type | Co-catalyst 2 |
| | | (Table 6 below) |
| Second Reactor Co-Catalyst 1 to Catalyst Molar Ratio (B to | Ratio | 30 |
| Catalyst Metal ratio) | | |
| Second Reactor Co-Catalyst 2 to Catalyst Molar Ratio (Al to | Ratio | 300 |
| Catalyst Metal ratio) | | |
| Second Reactor Residence Time | min | 21 |

TABLE 5
Catalysts and Co-catalysts for Example Resin 8 Synthesis

| | |
|---|---|
| Catalyst component 1 | 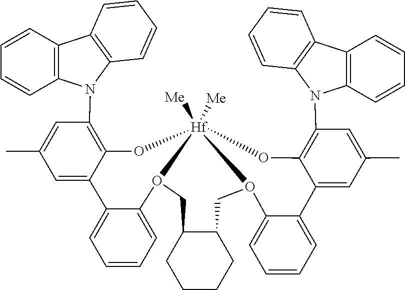 |
| Catalyst component 2 | 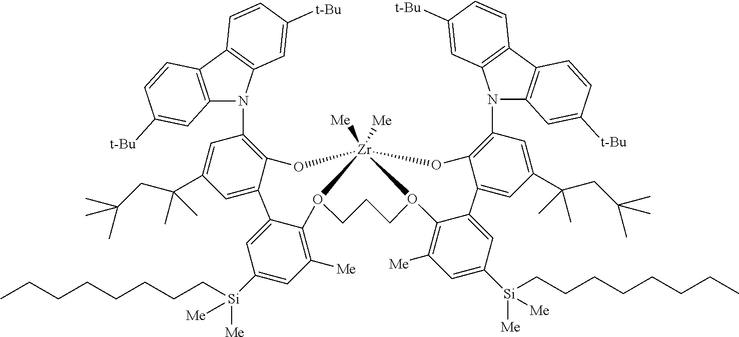 |
| Co-catalyst 1 | bis(hydrogenated tallow alkyl)methylammonium tetrakis(pentafluorophenyl)borate(1-) |
| | amine |
| Co-catalyst 2 | Modified methyl aluminoxane |

### Making of Example PCR Resin Formulations

PCR resin formulations and AV100 having the compositions listed in Table 6 were produced by gravimetrically feeding the required proportions of the PCR resin pellets and virgin polyethylene resin formulation pellets (and any other components if needed) into the feed section of a mixer, where they were conveyed, melted and mixed therein. The mixers used were a twin screw extruder, Farrel continuous mixer, and a Banbury mixer or a Buss kneader. The mixer was equipped with devolatilization section to remove any volatiles. For samples produced with the twin screw extruder, the mixed polymer melt was passed from the mixer to a gear pump which pumped the polymer melt through a screen changer equipped with screen packs having a combination of screens with the finest screen being 325 mesh to remove undesired contaminants. The filtered polymer melt then flowed through the die holes and was pelletized using either an underwater pelletizer or a strand pelletizer. The cut pellets were then dewatered and dried and collected.

TABLE 6
Compositions of PCR Resin Formulations and
Comparative PCR containing Formulations

| PCR Resin | | | | |
|---|---|---|---|---|
| Formulations | | | | |
| CE = Comparative | | Ethylene/alpha- | | |
| Example | | olefin | | |
| E = Inventive Example | PCR | copolymer | HDPE | Density (g/cc) |
| PCR Pellet | 100% AV100 | — | — | 0.919 |
| CE2 | 70 wt. % | 30 wt. % | — | 0.918 |
| | AV100 | DOWLEX | | |
| | | 8070G | | |
| CE3 | 70 wt. % | 30 wt. % | — | — |
| | AV100 | DOWLEX | | |
| | | 2020G | | |
| CE4 | 70 wt. % | 30 wt. % XUS | — | — |
| | AV100 | 59999.31 | | |
| CE5 | 70 wt. % | 30 wt. % | — | 0.919 |
| | AV100 | INNATE ST 50 | | |
| E6 | 70 wt. % | 10 wt % XUS | 20% DMDA | 0.925 |
| | AV100 | 59999.31 | 6400 | |
| E7 | 70 wt. % | 15 wt % XUS | 15% DMDA | 0.923 |
| | AV100 | 59999.31 | 6400 | |
| E8 | 70 wt. % | 20 wt % XUS | 10% DMDA | 0.920 |
| | AV100 | 59999.31 | 6400 | |

TABLE 7
iCCD data for PCR Resin Formulations and
Comparative Formulations of Table 6

| | | ICCD wt | | |
|---|---|---|---|---|
| | ICCD wt | fraction | | |
| PCR Resin | fraction | between | I₂ (g/10 | I₁₀ (g/10 |
| Formulation | 99-115° C. | 35-90° C. | min) | min) |
| PCR Pellet | 5.01% | 69.86% | 2.26 | 18.1 |
| CE2 | 4.25% | 73.91% | 1.58 | 12.4 |
| CE5 | 5.07% | 68.56% | 1.66 | 12.9 |
| E6 | 16.98% | 60.23% | 1.59 | 14.4 |
| E7 | 13.05% | 65.72% | 1.53 | 13.3 |
| E8 | 8.52% | 71.25% | 1.46 | 12.4 |

In Table 8 as follows, additional virgin resin formulations are listed. Furthermore, Table 9 includes additional properties for the virgin resin formulation component of inventive PCR resin formulations and comparative resin formulations.

TABLE 8
Virgin Polyethylene Resin Formulations (Compositions
are given in weight percent)

| | Ethylene/alpha- | | |
|---|---|---|---|
| Virgin Resin | olefin | | Virgin Resin |
| Formulation | copolymer | HDPE | Density (g/cc) |
| CE1 | 100% XUS | — | 0.917 |
| | 60911.06 | | |
| CE6 | 100% Example | — | 0.919 |
| | Resin 3 | | |
| CE7 | 100% Example | — | 0.919 |
| | Resin 1 | | |
| CE8 | 100% Example | — | 0.918 |
| | Resin 7 | | |
| CE9 | 100% Example | — | 0.918 |
| | Resin 6 | | |
| Virgin Resin in E6 | 33.3% XUS | 66.67% | 0.944 |
| | 59999.31 | DMDA 6400 | |
| Virgin Resin in E7 | 50% XUS | 50% DMDA | 0.934 |
| | 59999.31 | 6400 | |
| Virgin Resin in E8 | 66.67% XUS | 33.3% DMDA | 0.924 |
| | 59999.31 | 6400 | |
| E9 | 80% Example | 20% DMDA | 0.917 |
| | Resin 4 | 6400 | |
| E10 | 80% Example | 20% DMDA | 0.916 |
| | Resin 2 | 6400 | |
| E11 | 80% Example | 20% DMDA | 0.917 |
| | Resin 5 | 6400 | |
| E12 | 100% Example | — | 0.918 |
| | Resin 8 | | |

TABLE 9
iCCD data for Virgin Polyethylene Resin Formulations

| | | ICCD wt | | |
|---|---|---|---|---|
| | ICCD wt | fraction | | |
| Virgin Resin | fraction | between | I₂ (g/10 | I₁₀ (g/10 |
| Formulation | 99-115° C. | 35-90° C. | min) | min) |
| Virgin Resin in CE2 | 3.94% | 79.01% | 0.89 | 6.62 |
| Virgin Resin in CE3 | 6.14% | 77.82% | 0.5 | 4.08 |
| Virgin Resin in CE4 | 0.07% | 98.68% | 0.5 | 4.18 |
| Virgin Resin in CE5 | 4.31% | 67.99% | 0.88 | 7.00 |
| CE6 | 4.30% | 70.26% | 0.27 | 1.67 |
| CE7 | 5.44% | 61.31% | 0.17 | 1.01 |
| CE8 | 0.83% | 65.22% | 0.27 | 2.36 |
| CE9 | 0.67% | 71.23% | 0.61 | 4.70 |
| Virgin Resin in E6 | 44.31% | 37.20% | 0.57 | 8.0 |
| Virgin Resin in E7 | 38.03% | 45.59% | 0.46 | 6.52 |
| Virgin Resin in E8 | 24.71% | 63.72% | 0.51 | 5.37 |
| E9 | 12.59% | 72.87% | 0.26 | 2.08 |
| E10 | 15.11% | 68.63% | 0.13 | 1.02 |
| E11 | 10.67% | 60.96% | 0.52 | 4.78 |
| E12 | 8.38% | 63.54% | 0.89 | 6.39 |

### 0.9 mil Films Produced on 8″ Diameter Lines

Monolayer films having a target thickness of 0.9 mils were produced from the inventive examples and comparative examples on an 8″ diameter die blown film line and included the components listed in Table 12. The additive masterbatch included 900 ppm of erucamide and 5000 ppm of talc. The blown film line was equipped with a screw single screw extruder using a 3.5 inch Davis Standard Barrier II screw. The target temperature profile during extrusion was 177′ C, 224° C., 193° C., 177° C., 177° C., 221° C., 227° C. through barrels 1-5, the screen block, and lower-upper die, respectively. To produce the films, the compositions are sent to the 8 inch diameter blown film die with a 100 mil die gap and an output rate of 10 lb/hr/in. of die circumference. A target melt temperature is 212° C., and the blow-up ratio was maintained at 2. The air temperature in the air ring and air cooling unit was 7.2° C. The frost line height was an average of 35 inches. Film thickness was controlled within +10% at 0.9 mils by adjusting the nip roller speed. The films are wound up into a roll. General blown film parameters, used to produce each blown film, are shown in Table 11 below. The temperature profile are the temperatures starting closest to the pellet hopper (Barrel 1), and in increasing order, as the polymer was extruded through the die.

TABLE 10
Single Screw Extruder Parameters

| | |
|---|---|
| Blow up ratio (BUR) | 2 |
| Film thickness (mil) | 0.9 |
| Die gap (mil) | 100 |
| Air temperature (° C.) | 7.2 |
| Die diameter (inch) | 8 |

Temperature profile (° C.)

| | |
|---|---|
| Barrel 1 | 177 |
| Barrel 2 | 224 |
| Barrel 3 | 193 |
| Barrel 4 | 177 |
| Barrel 5 | 177 |
| Screen Temperature | 221 |
| Adapter | 221 |
| Block | 221 |
| Lower Die | 227 |
| Inner Die | 227 |
| Upper Die | 227 |

TABLE 11
Film compositions for the 8″ die blown film line

| | | Overall | Ethylene/alpha- | | Additives | Film |
|---|---|---|---|---|---|---|
| Film | | PCR | olefin copolymer | | (slip, | Density |
| CF = Comparative Film | Pellet | content | (E/AO) | | antiblock | (by blend |
| F = Inventive Film | Sample | (wt. %) | component 1 | HDPE | masterbatch) | rule)* |
| CF1 | 100% CE1 | — | — | — | — | 0.917 |
| CF2 | 30 wt. % | 21% | 69 wt. % | — | 1% | 0.916 |
| | CE2 | | XUS | | | |
| | | | 60911.06 | | | |
| CF3 | 30 wt. % | 21% | 69 wt. % | — | 1% | 0.917 |
| | CE3 | | XUS | | | |
| | | | 60911.06 | | | |
| CF4 | 30 wt. % | 21% | 69 wt. % | — | 1% | 0.915 |
| | CE4 | | XUS | | | |
| | | | 60911.06 | | | |
| CF7 | 30 wt. % | 21% | 69 wt. % | — | 1% | 0.916 |
| | CE5 | | XUS | | | |
| | | | 60911.06 | | | |
| CF8 | 100 wt % | — | — | — | — | 0.917 |
| | CE1 | | | | | |
| CF9 | 72 wt. % | 50.4% | 27 wt. % | — | 1% | 0.915 |
| | CE2 | | XUS | | | |
| | | | 60911.06 | | | |
| CF10 | 72 wt. % | 50.4% | 27 wt. % | — | 1% | 0.916 |
| | CE3 | | XUS | | | |
| | | | 60911.06 | | | |
| CF11 | 72 wt. % | 50.4% | 27 wt. % | — | 1% | 0.913 |
| | CE4 | | XUS | | | |
| | | | 60911.06 | | | |
| CF14 | 72 wt. % | 50.4% | 27 wt. % | — | 1% | 0.916 |
| | CE5 | | XUS | | | |
| | | | 60911.06 | | | |
| F5 | 30 wt. % | 21% | 63 wt. % | 6 wt % | 1% | 0.918 |
| | CE4 | | XUS | DMDA | | |
| | | | 60911.06 | 6400 | | |
| F6 | 30 wt. % | 21% | 50 wt. % | 19 wt % | 1% | 0.917 |
| | CE4 | | XUS | DMDA | | |
| | | | 59999.31 | 6400 | | |
| F12 | 72 wt. % | 50.4% | 18 wt % | 9 wt % | 1% | 0.917 |
| | CE4 | | XUS | DMDA | | |
| | | | 60911.06 | 6400 | | |
| F13 | 72 wt. % | 50.4% | 15 wt % | 12 wt % | 1% | 0.916 |
| | CE4 | | XUS | DMDA | | |
| | | | 59999.31 | 6400 | | |

*Blend rule utilized the following calculation → 1/(average density) = 1/(sum of {wt fraction of each component/(density of each component)}).

TABLE 12
iCCD data of the combination of the ethylene/alpha
olefin copolymer and the HDPE (Virgin Polyethylene
Resin) but without PCR in film

| | ICCD wt | ICCD wt | | |
|---|---|---|---|---|
| | fraction | fraction | | |
| | between 99- | between 35- | I₂ | I₁₀ |
| Product Name | 115° C. | 90° C. | (g/10 min) | (g/10 min) |
| CF1 - PCR | 3.28% | 81.64% | 0.9 | 7.1 |
| CF2 -PCR | 3.28% | 81.64% | 0.9 | 7.1 |
| CF3 -PCR | 3.91% | 79.82% | 0.78 | 6.12 |
| CF4 -PCR | 3.24% | 82.57% | 0.74 | 6.08 |
| CF7 -PCR | 4.23% | 78.37% | 0.78 | 6.38 |
| CF8 -PCR | 3.28% | 81.64% | 0.9 | 7.1 |
| CF9 -PCR | 3.28% | 81.64% | 0.9 | 7.1 |
| CF10 -PCR | 4.70% | 77.98% | 0.58 | 5.10 |
| CF11 -PCR | 1.96% | 88.87% | 0.57 | 5.10 |
| CF14 -PCR | — | 73.06% | 0.77 | 6.30 |
| F5 - PCR | 8.90% | 75.73% | 0.69 | 5.97 |
| F6 -PCR | 13.19% | 79.29% | 0.37 | 4.35 |
| F12 -PCR | 12.47% | 75.76% | 0.54 | 5.31 |
| F13 -PCR | 16.64% | 74.28% | 0.37 | 4.43 |

TABLE 13
Film Properties from 8″ Film Line

| | | | | Avg | Avg | |
|---|---|---|---|---|---|---|
| | Overall | Overall | Additives | Secant | Secant | |
| | PCR | E/AO + | (slip, | Modulus at | Modulus at | |
| | amount | HDPE | antiblock | 2% (CD) | 2% (MD) | Dart |
| Film | (wt. %) | (wt. %) | masterbatch) | (psi) | (psi) | (g) |
| CF1 | — | 100% | — | 24234 | 21745 | 552 |
| CF2 | 21% | 78% | 1% | 25940 | 22507 | 408 |
| CF3 | 21% | 78% | 1% | 25984 | 24571 | 246 |
| CF4 | 21% | 78% | 1% | 21460 | 20379 | 513 |
| CF7 | 21% | 78% | 1% | 22725 | 22192 | 413 |
| CF8 | — | 100% | — | 24234 | 21745 | 552 |
| CF9 | 50.4% | 48.6% | 1% | 27220 | 21884 | 146 |
| CF10 | 50.4% | 48.6% | 1% | 22838 | 20802 | 189 |
| CF11 | 50.4% | 48.6% | 1% | 23275 | 20492 | 464 |
| CF14 | 50.4% | 48.6% | 1% | 22963 | 19879 | 185 |
| F5 | 21% | 78% | 1% | 31426 | 27195 | 396 |
| F6 | 21% | 78% | 1% | 34912 | 29037 | 414 |
| F12 | 50.4% | 48.6% | 1% | 31183 | 26943 | 185 |
| F13 | 50.4% | 48.6% | 1% | 34043 | 25728 | 273 |

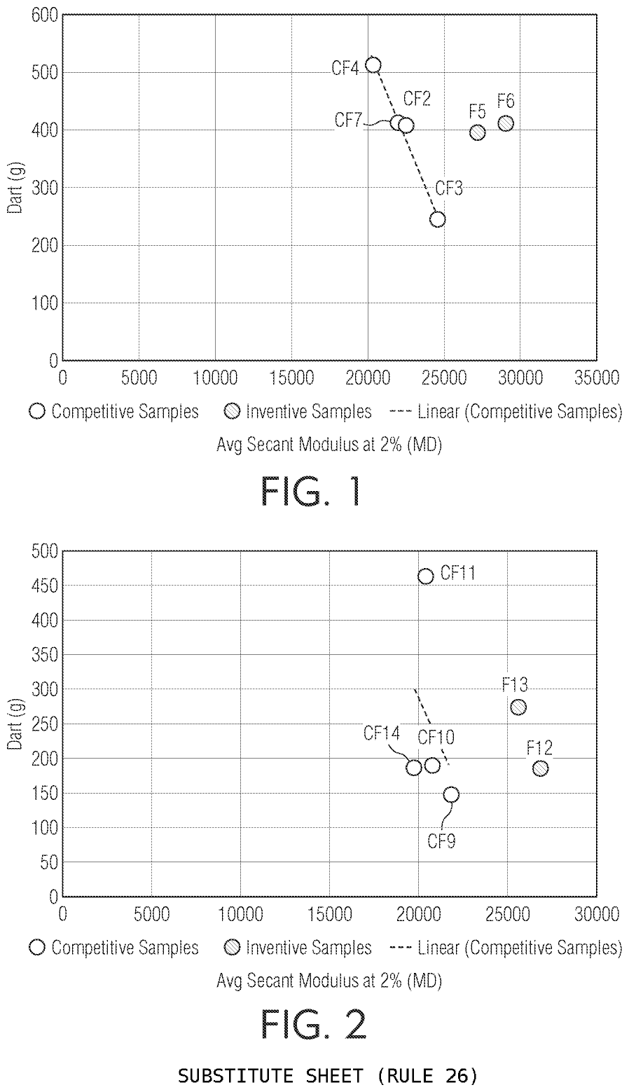

As shown in Table 13 and FIG. 1, Inventive Films F5 and F6, which include 21% PCR content, demonstrated a higher stiffness and toughness balance versus the Comparative Films CF2-CF4, and CF7 as demonstrated by the Dart and Secant Modulus values. Similarly as shown, Inventive Films F12 and F13, which include 50.4% PCR content, demonstrated a higher stiffness and toughness balance versus the Comparative Films CF9-CF 11, and CF14 as demonstrated by the Dart and Secant Modulus values.

### 2 mil Films Produced on 2″ Diameter Lines

Monolayer blown films having a target thickness of 2.0 mils were also produced using a 2″ die diameter blown film line. Gravimetric feeders dosed resin formulations into a Labtech LTE20-32 twin screw extruder at rate of 15 lbs/hr. From the extruder the resin formulation is conveyed into the 2″ die diameter die with gap of 1.0 mm. The LTE feed throat was set to 193° C. and the remaining barrel, conveying portion, and die temperature were set and maintained to 215° C. To produce films an output rate of 2.4 lb/hr/in. of die circumference was targeted with pressurized ambient air inflating the film bubble to a 2.5 blow-up ratio. A dual lip air ring driven by a variable speed blower is used for all experiments. The frost line height (FLH) was maintained between 9.3 and 10.3 inches. Film thickness was targeted at 2 mils and was controlled within 10% by adjusting the nip roller speed. The films are wound up into a roll.

TABLE 14
Film compositions for the 2″ die blown film line

| | | Overall | Ethylene/alpha- | | Additives | Film |
|---|---|---|---|---|---|---|
| Film | | PCR | olefin copolymer | | (slip, | Density |
| CF = Comparative Film | Pellet | content | (E/AO) | | antiblock | (by blend |
| F = Inventive Film | Sample | (wt. %) | component | HDPE | masterbatch) | rule)* |
| CF15 | CP6 | 25.00% | 75 wt % | — | — | |
| | | | Example | | | |
| | | | Resin 3 | | | |
| CF16 | CP7 | 25.00% | 75 wt % | — | — | |
| | | | Example | | | |
| | | | Resin 4 | | | |
| CF17 | CP8 | 25.00% | 75 wt % | — | — | 0.919 |
| | | | Example | | | |
| | | | Resin 7 | | | |
| CF18 | CP9 | 25.00% | 75 wt % | — | — | 0.919 |
| | | | Example | | | |
| | | | Resin 6 | | | |
| CF19 | CP6 | 50.00% | 50 wt % | — | — | 0.919 |
| | | | Example | | | |
| | | | Resin 3 | | | |
| CF20 | CP8 | 50.00% | 50 wt % | — | — | 0.919 |
| | | | Example | | | |
| | | | Resin 7 | | | |
| CF21 | CP9 | 50.00% | 50 wt % | — | — | 0.919 |
| | | | Example | | | |
| | | | Resin 6 | | | |
| F14 | P9 | 25.00% | 60 wt % | 15 wt % | — | |
| | | | Example | DMDA | | |
| | | | Resin 4 | 6400 | | |
| F15 | P10 | 25.00% | 60 wt % | 15 wt % | — | 0.918 |
| | | | Example | DMDA | | |
| | | | Resin 2 | 6400 | | |
| F16 | P11 | 25.00% | 63.75 wt % | 11.25 wt % | — | 0.918 |
| | | | Example | DMDA | | |
| | | | Resin 5 | 6400 | | |
| F17 | P9 | 50.00% | 40 wt % | 10 wt % | — | 0.919 |
| | | | Example | DMDA | | |
| | | | Resin 4 | 6400 | | |
| F18 | P11 | 50.00% | 42.5 wt % | 7.5 wt % | — | 0.919 |
| | | | Example | DMDA | | |
| | | | Resin 5 | 6400 | | |
| F19 | P12 | 25.00% | 75 wt % | — | | 0.918 |
| | | | Example | | | |
| | | | Resin 8 | | | |
| F20 | P12 | 50.00% | 50 wt % | — | | 0.918 |
| | | | Example | | | |
| | | | Resin 8 | | | |

*Blend rule utilized the following calculation → 1/(average density) = 1/(sum of {wt fraction of each component/(density of each component)}).

TABLE 15
Film Properties from 2″ Film Line

| | | | | Avg | Avg | Instrumental |
|---|---|---|---|---|---|---|
| | | | Additives | Secant | Secant | Dart |
| | Overall | Overall | (slip, | Modulus | Modulus | Impact - |
| | PCR | E/AO + | antiblock | at 2% | at 2% | total |
| | amount | HDPE | masterbatch) | (CD) | (MD) | Energy |
| Film | (wt %) | (wt %) | (wt %) | (psi) | (psi) | (J) |
| CF15 | 25% | 75% | — | 24206 | 25969 | 1.1 |
| CF16 | 25% | 75% | — | 19826 | 23715 | 1.2 |
| CF17 | 25% | 75% | — | 22679 | 20396 | 1.5 |
| CF18 | 25% | 75% | — | 20822 | 21958 | 0.4 |
| CF19 | 50% | 50% | — | 20063 | 20146 | 0.4 |
| CF20 | 50% | 50% | — | 22694 | 20029 | 0.6 |
| CF21 | 50% | 50% | — | 21416 | 19671 | 0.4 |
| F14 | 25% | 75% | — | 22264 | 21721 | 4.5 |
| F15 | 25% | 75% | — | 24357 | 23150 | 5.0 |
| F16 | 25% | 75% | — | 23339 | 23892 | 2.7 |
| F17 | 50% | 50% | — | 21715 | 20885 | 0.8 |
| F18 | 50% | 50% | — | 21438 | 20586 | 0.8 |
| F19 | 25% | 75% | — | 28767 | 33093 | 2.6 |
| F20 | 50% | 50% | — | 26825 | 29024 | 0.9 |

As shown in Table 15, Inventive Films F14-F16 and F19, which include 25% PCR content demonstrated Dart values higher than CF15-18. Further as shown, Inventive Films F17, F18, and F20, which include 50% PCR content, demonstrated higher Dart values than CF19-CF21.

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A post-consumer recycled (PCR) resin formulation comprising: PCR resin comprising a blend of polyethylene recovered from post-consumer material, pre-consumer material, or combinations thereof; and virgin polyethylene resin formulation, wherein:
the virgin polyethylene resin formulation comprises:
a density from 0.910 to 0.950 g/cc,
an improved comonomer content distribution (iCCD) wt. fraction greater than 30 wt. % at a temperature range of 35 to 90° C., the iCCD wt. fraction being defined as a ratio of the mass eluted at temperatures from 35 to 90° C. for the virgin polyethylene resin to the total mass eluted for the virgin polyethylene resin when measured using an iCCD curve of mass eluted versus temperature, and
an iCCD wt. fraction greater than 8 wt. % at a temperature range of 99 to 115° C.;
the PCR resin formulation comprises:
an overall density of from 0.910 to 0.930 g/cc;
an iCCD second elution peak occurring at a temperature greater than 99° C.;
an iCCD wt. fraction greater than 6 wt. % at a temperature range of 99 to 115° C., the iCCD wt. fraction being defined as a ratio of the mass eluted at temperatures from 99 to 115° C. for the PCR resin formulation to the total mass eluted for the PCR resin formulation when measured using an iCCD curve of mass eluted versus temperature; and
an iCCD wt. fraction greater than 60 wt. % at a temperature range of 35 to 90° C.

2. The PCR resin formulation of claim 1, wherein the PCR resin formulation comprises from 10 to 75 wt. % of PCR resin.

3. The PCR resin formulation of claim 1, wherein the PCR resin comprises a differential scanning calorimeter (DSC) second heat of fusion of 120 J/g to 200 J/g.

4. The PCR resin formulation of claim 1, wherein the PCR resin has a density of 0.900 to 0.940 g/cc and a melt index I₂ from 0.5 to 6 g/10 min when measured at 190° C. and 2.16 kg.

5. The PCR resin formulation of claim 1, wherein the PCR resin has a count of defect with an equivalent circular diameter in the range of 200-400 μm (per 24.6 cm³ of film) greater than 500, and a count of defect with an equivalent circular diameter in the range of 400-800 μm (per 24.6 cm³ of film) greater than 250.

6. The PCR resin formulation of claim 1, wherein the PCR resin formulation comprises 25 wt. % to 90 wt. % of virgin polyethylene resin formulation.

7. The PCR resin formulation of claim 1, wherein the virgin polyethylene resin formulation comprises a blend of ethylene/alpha-olefin copolymer having a density of 0.850 g/cc to 0.915 g/cc and high density polyethylene (HDPE) resin, wherein the blend is a physical blend or an in-reactor bimodal blend.

8. The PCR resin formulation of claim 7, wherein the ethylene/alpha-olefin copolymer comprises linear low density polyethylene resin (LLDPE).

9. The PCR resin formulation of claim 8, wherein the LLDPE has a melt index, I₂, of less than 2.0 g/10 min when measured at 190° C. and 2.16 kg.

10. The PCR resin formulation of claim 7, wherein the HDPE has a density of 0.950 g/cc or greater.

11. The PCR resin formulation of claim 1, wherein the PCR resin formulation has an 12 of 0.1 to 2 g/10 mins and an I₁₀ of 1 to 15 g/10 mins.

12. A film having at least one layer, wherein the at least one layer comprises the PCR resin formulation of claim 1.
